(19) United States
(12) Patent Application Publication
(10) Pub. No.: US 2026/0121145 A1
(43) Pub. Date: Apr. 30, 2026

(54) SYSTEMS AND METHODS FOR CATHODE-TO-CATHODE UPCYCLING OF OXIDE CATHODE ACTIVE MATERIALS

(71) Applicant: Princeton NuEnergy Inc., Bordentown, NJ (US)

(72) Inventors: Jinyun LIAO, Newtown, PA (US); Hao LIU, Fremont, CA (US); Ryan ANDRIS, Philadelphia, PA (US); Chao YAN, Princeton, NJ (US); Xiaofang YANG, Ambler, PA (US)

(21) Appl. No.: 19/368,417

(22) Filed: Oct. 24, 2025

Related U.S. Application Data
(60) Provisional application No. 63/713,391, filed on Oct. 29, 2024.

(51) Int. Cl. H01M 10/54

(52) U.S. Cl. CPC H01M 10/54

(57) ABSTRACT

Some embodiments are directed to systems and methods for direct recycling of batteries. In one aspect, a method includes obtaining spent cathode materials from spent batteries. The method includes wet milling the spent cathode materials in an aqueous medium to obtain deagglomerated particles. The method includes spray drying the deagglomerated particles to obtain a plurality of clusters of particles. The method further includes annealing the plurality of clusters of particles in a gaseous environment to obtain a plurality of single particles.

### RELATED APPLICATIONS

This application claims priority to U.S. Provisional Application No. 63/713,391, filed Oct. 29, 2024, titled “Systems and Methods for Cathode-to-Cathode Upcycling of Oxide Cathode Active Materials,” which is incorporated by reference herein in its entirety.

### STATEMENT REGARDING FEDERALLY SPONSORED RESEARCH OR DEVELOPMENT

This invention was made with government support under Grant DE-EE0010400 awarded by the Department of Energy. The government has certain rights in the invention.

### TECHNICAL FIELD

The present application generally relates to methods and systems for battery recycling.

### BACKGROUND

Lithium ion batteries are widely used in portable electronic devices, electric vehicles, and home energy storage systems. Despite the increased use of lithium ion batteries, technologies to optimize recycling of these batteries have not kept pace.

### SUMMARY

Lithium ion batteries are one of the most common energy sources and are used in applications such as portable electronic devices such as cellphones and laptop computers, home energy storage systems, and electric vehicles (EV). Amongst these applications, the market for electric vehicles has experienced rapid growth in recent years. In 2022, about 60% of lithium, 30% of cobalt and 10% of nickel demand was for EV batteries. Just five years earlier, in 2017, these shares were around 15%, 10% and 2%, respectively. The rapid growth in EV deployment will inevitably be followed by a corresponding rise in the supply of end-of-life vehicles and their lithium ion batteries, which can present a serious waste-management challenge for recyclers at end-of-life.

Currently, pyrometallurgy, hydrometallurgy, and conventional direct recycling are the three main pathways for recycling lithium ion batteries. Although these processes are generally effective, they are very costly and typically only enable the recovery of specific metals, and in material forms that are of low value to battery manufacturers. Furthermore, different EVS on the market can have a variety of physical configurations, cell types, and cell chemistries, which can present challenges in terms of disassembly and applications for re-use.

Recycling batteries is important for many reasons, including reducing waste, conserving natural resources, reducing the cost and energy use of manufacturing, securing the sustainable production of new lithium ion batteries, continuing to meet the demand for critical elements and materials such as lithium, cobalt, manganese, and graphite, and continuing to address issues related to the clean energy transition such as the demand for minerals needed for electric vehicles and renewable energy storage systems.

In view of the aforementioned reasons, there is a need for improved systems and methods for battery recycling. Specifically, decreasing the cost of recycling and improving the recycling rate can significantly reduce the life cycle cost of lithium ion batteries, avoid material shortages, lessen the environmental impact of new material production, and provide low-cost active materials for the manufacturing of new lithium ion batteries. With the large increase in cell production expected in the next decade, primary scrap from production is another key source for global recycling efforts.

Some embodiments of the present disclosure are directed to improved methods and systems for direct recycling of lithium ion batteries. As used herein, direct recycling refers to the recovery, regeneration, and reuse of battery components directly without breaking down the chemical structure. Direct recycling is also referred to as direct cathode recycling and cathode-to-cathode recycling.

Direct recycling is a promising approach for recycling lithium ion batteries because it can directly recycle and/or regenerate cathode and anode materials while keeping the cathode crystal structure intact (e.g., it does not destroy the chemical composition).

In particular, some embodiments disclosed herein pertain to direct cathode-to-cathode material recycling, where cathode materials from spent lithium ion batteries (also referred to herein as “spent cathode materials”) are processed and reused in new batteries (also referred to herein as “recycled cathode materials”). In some embodiments, the spent cathode material is upgraded or upcycled through a physical change in morphology (e.g., shape or size) without a corresponding change in chemical composition. In some embodiments, the spent cathode material is upgraded or upcycled through a physical change in morphology (e.g., shape or size) with a corresponding change in chemical composition. In some embodiments, the spent cathode material is upgraded or upcycled through a change in particle crystallinity (e.g., from polycrystallinity to single crystallinity, or from single crystallinity to polycrystallinity). In some embodiments, the recycled cathode material has the same stoichiometry as the spent cathode material. In some embodiments, the spent cathode material is upgraded or upcycled by chemically changing its composition (or stoichiometry) from an initial chemical composition to an upcycled chemical composition. In some embodiments, the spent cathode material is upgraded or upcycled by re-lithiating the spent cathode material to increase a current content of lithium n the spent cathode material. An example cathode material is lithium nickel manganese cobalt oxide (NMC). Other examples of cathode materials include lithium (Li) transition metal oxides such as lithium cobalt oxide (LCO or LiCoO₂), lithium manganese oxide (LMO or LiMn₂O₄), lithium iron phosphate (LFP or LiFePO₄), lithium nickel cobalt aluminum oxide (NCA or LiNiₓCo_{y}Al_{z}O₂). In some examples, upgrading or upcycling spent cathode materials comprises changing a chemical composition of NMC from NMC 111 chemical composition (e.g., LiNi_{0.33}Mn_{0.33}Co_{0.33}O₂, having equal atomic parts of nickel, manganese, and cobalt) in the spent cathode material to the NMC 622 (e.g., Li_{1.08}Ni_{0.63}Co_{0.19}Mn_{0.18}O₂) chemical composition or the NMC 811 chemical composition (e.g., Li_{1.08}Ni_{0.79}Co_{0.11}Mn_{0.10}O₂) in the recycled cathode material.

In accordance with some embodiments, the direct recycling techniques disclosed herein advantageously distinguish over current processes for commercially recycling lithium ion batteries. Specifically, the direct recycling techniques disclosed herein use less energy, less chemicals, and are cheaper compared to pyrometallurgy and hydrometallurgy approaches. The disclosed direct recycling techniques also provide a lower cost solution compared to current direct recycling technologies. In real battery waste streams, there may be a large variety of cell types with different states of health. The current industry practice of cathode-to-cathode direct recycling is to pre-screen the purified cathode particles from the spent batteries/manufacturing scrap, to identify a subset of polycrystalline particles with “better” states of health for processing. To be specific, the particles that are selected for current direct recycling (also referred to herein as “conventional direct recycling”) tend to be those whose physical structures are preserved or intact (e.g., particles that are not fractured or cracked), and which require restoration of their chemical compositions and lattice structures via re-lithiation. Accordingly, the current industry practice of cathode-to-cathode direct recycling screens huge amounts of particles, but rejects a large portion of particles that are cracked or otherwise physically defective. The rejected particles are then re-routed for recycling using conventional hydrometallurgy and pyrometallurgy processes. The pre-selection process severely limits both the amount and potential of cathode-to-cathode direct recycling.

Disclosed herein are improved methods and systems for cathode-to-cathode direct recycling or upcycling. Specifically, the techniques as disclosed herein eliminate the pre-screening stage that is present in current conventional direct recycling approaches, and can process all spent cathode materials, regardless of their state of health and physical structures.

In one aspect, a method for direct recycling of batteries (e.g., cathode-to-cathode direct recycling) comprises obtaining spent cathode materials (e.g., black mass or electrode materials) from spent batteries, wet milling the spent cathode materials in an aqueous medium to obtain deagglomerated particles of the spent cathode materials, spray drying the deagglomerated primary particles to obtain a plurality of clusters of particles, and annealing the plurality of clusters of particles in a gaseous environment to obtain a plurality of single particles (e.g., particles that are non-agglomerated, non-clustered, or non-aggregated). Specifically, in some embodiments, the spent cathode materials used in the disclosed methods include materials (e.g., particles) that have cracks or fractures.

In some embodiments, the aqueous medium includes water.

In some embodiments, the method includes, while wet milling the spent cathode materials, adding a water-soluble polymer binder to an aqueous suspension of the spent cathode materials. In some embodiments, the polymer binder includes one or more of: Methylcellulose (MC), Carboxymethyl Cellulose (CMC), Hydroxyethyl Cellulose (HEC), Hydroxypropyl Methylcellulose (HPMC), Carrageenan, polyvinyl alcohol (PVA), (polyethylene glycol) PEG, polyvinylpyrrolidone (PVP), Polypyrene (PPY), Polyacrylic Acid (PAA), and Poly (methyl methacrylate) (PMMA).

In some embodiments, the method includes, while wet milling the spent cathode materials, adding one or more additives to an aqueous suspension of the spent cathode materials. In some embodiments, the one or more additives include one or more of: LiOH, Li₂CO₃, NaOH, Na₂CO₃, nickel oxide/carbonate, cobalt oxide/carbonate, manganese oxide/carbonate, and aluminum oxide.

In some embodiments, the gaseous environment is air. In some embodiments, the gaseous environment is a predominantly oxygen environment (e.g., at least 51% oxygen by volume mixture, at least 60% oxygen by volume mixture, at least 70% oxygen by volume mixture, at least 80% oxygen by volume mixture, at least 85% oxygen by volume mixture, at least 90% oxygen by volume mixture, or at least 95% oxygen by volume mixture).

In some embodiments, the method includes, after annealing the plurality of clusters of particles to obtain the plurality of single particles: subjecting the plurality of single particles to a deagglomeration process to obtain a plurality of smaller-sized single particles. For example, in some embodiments, the annealing step (see above paragraph) can cause multiple single particles to sinter and agglomerate. This deagglomeration process is applied to de-agglomerate the particles.

In some embodiments, the deagglomeration process comprises a jet milling process. In some embodiments, the deagglomeration process comprises a wet milling process. In some embodiments, the deagglomeration process comprises a dry milling process. In some embodiments, the annealing is a first annealing process and the deagglomeration process is a first deagglomeration process. The method further includes, after the first deagglomeration process: mixing the plurality of smaller-sized single particles with LiOH/Li₂CO₃ or NaOH/Na₂CO₃ to obtain a mixture of particles; and subjecting the mixture of particles to a second annealing process, to obtain agglomerates of particles.

In some embodiments, a temperature of the first annealing process is higher than a temperature of the second annealing process.

In some embodiments, the method includes, after the second annealing process, subjecting the agglomerates of particles to a second deagglomeration process.

In some embodiments, the method includes, after obtaining the plurality of single particles, mixing (e.g., combining) the plurality of single particles with cathode active material (CAM) particles synthesized from pyrometallurgy or hydrometallurgy processes or the conventional state-of-the-art CAM manufacturing process.

In another aspect, a method for direct recycling of batteries (e.g., cathode-to-cathode direct recycling, or using direct recycled cathode materials comprises obtaining a plurality of single (e.g., individual) particles that are processed via direct recycling, and combining the plurality of single particles with cathode active material (CAM) particles synthesized from pyrometallurgy or hydrometallurgy processes or a conventional state-of-the-art CAM manufacturing process. In some embodiments, the direct recycling includes one or more steps of wet milling, spray drying, or annealing.

In another aspect, a system for direct recycling of batteries includes processing circuitry and memory, The memory stores instructions that are configured to be executed by the processing circuitry. The instructions, when executed by the processing circuitry, cause the system to perform any of the methods disclosed herein.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the inventive subject matter.

### BRIEF DESCRIPTION OF THE DRAWINGS

The accompanying drawings, which are included to provide a further understanding of the embodiments, are incorporated herein, constitute a part of the specification, illustrate the described embodiments, and, together with the description, serve to explain the underlying principles.

FIG. 1A illustrates current approaches for recycling lithium ion batteries, in accordance with some embodiments.

FIG. 1B is a scanning electron microscope (SEM) image of an example particle (e.g., recovered metal materials 130 or recovered materials) generated from the recovery step in pyrometallurgy or the precipitation step in hydrometallurgy.

FIG. 1C is a SEM image of an example NMC particle that is generated from the cathode synthesis step in pyrometallurgy or hydrometallurgy, or from the relithiation or upcycling step in conventional direct recycling.

FIGS. 2A and 2B compares the current approaches for recycling lithium ion batteries, in accordance with some embodiments.

FIG. 2C is a chart illustrating the cost and environmental impacts to produce 1 kg of NMC 111.

FIG. 3 illustrates an exemplary process for direct recycling of batteries (e.g., cathode-to-cathode direct recycling or upcycling), in accordance with some embodiments.

FIG. 4A shows a series of scanning electron microscope (SEM) images illustrating the morphology changes in cathode active material (CAM) particles as they undergo the steps of wet milling, spray drying, and annealing, in accordance with some embodiments.

FIG. 4B shows an energy dispersive X-ray (EDS) spectrum of a cluster of particles after the spray-drying process.

FIG. 4C shows X-ray diffraction data of (i) the oxide-based CAM 302 particles (denoted as PC-622) before they undergo the steps of the workflow 300 and (ii) the particles after the first annealing step (denoted in SC-622).

FIG. 5 illustrates morphological and size distribution changes of CAM materials during upcycling from NMC 111 to NMC 622, in accordance with some embodiments.

FIGS. 6A and 6B provide a flowchart of an example method for direct recycling of batteries, in accordance with some embodiments.

FIG. 7 provides a flowchart of an example method for direct recycling of batteries, in accordance with some embodiments.

FIG. 8 illustrates an exemplary system 800 for performing the direct recycling processes disclosed herein, in accordance with some embodiments.

FIG. 9 are SEM images showing the morphological changes in a sample of NMC 622 polycrystalline particles that undergo morphology upgrading from polycrystalline NMC 622 from single crystal NMC 622 particles, in accordance with some embodiments.

Like reference numerals refer to corresponding parts throughout the several views of the drawings.

### DETAILED DESCRIPTION

Reference will now be made in detail to specific embodiments, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of the claims and the subject matter may be practiced without these specific details. For example, it will be apparent to one of ordinary skill in the art that the subject matter presented herein can be implemented on many types of electronic devices with digital video capabilities.

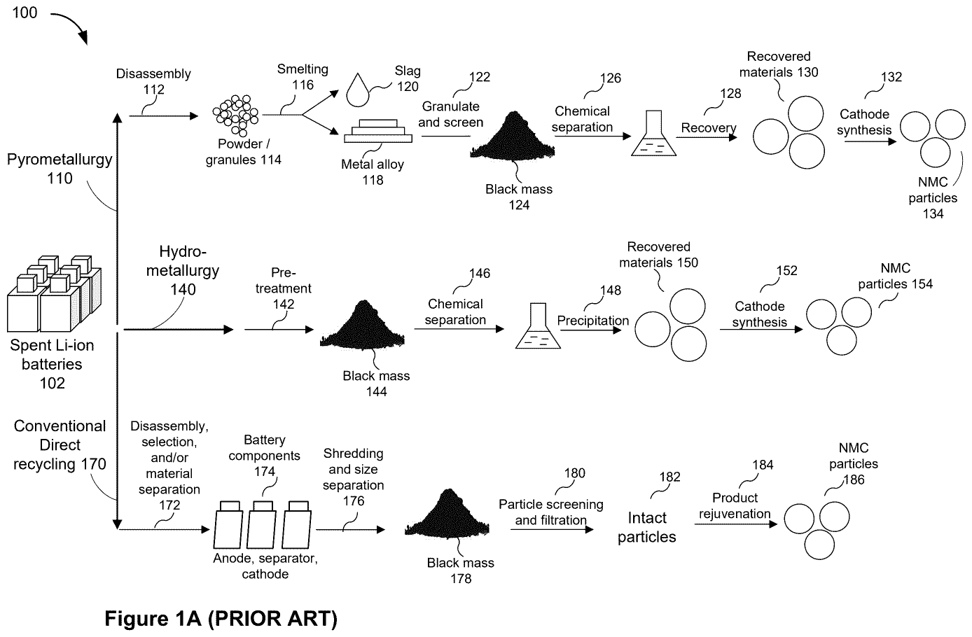

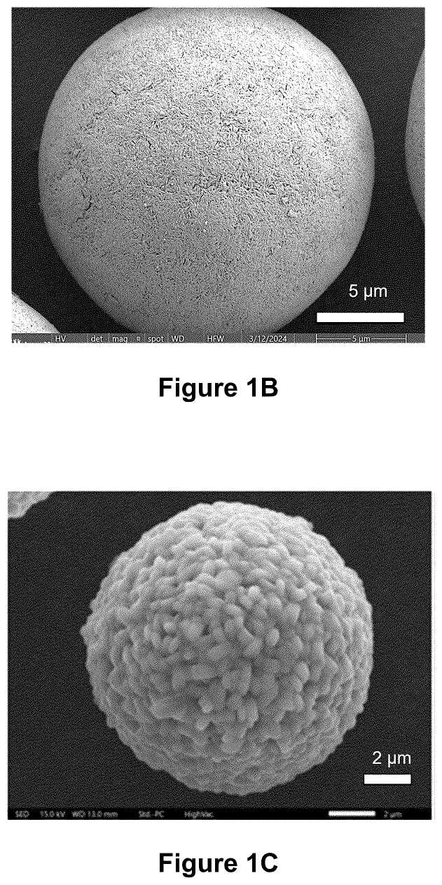

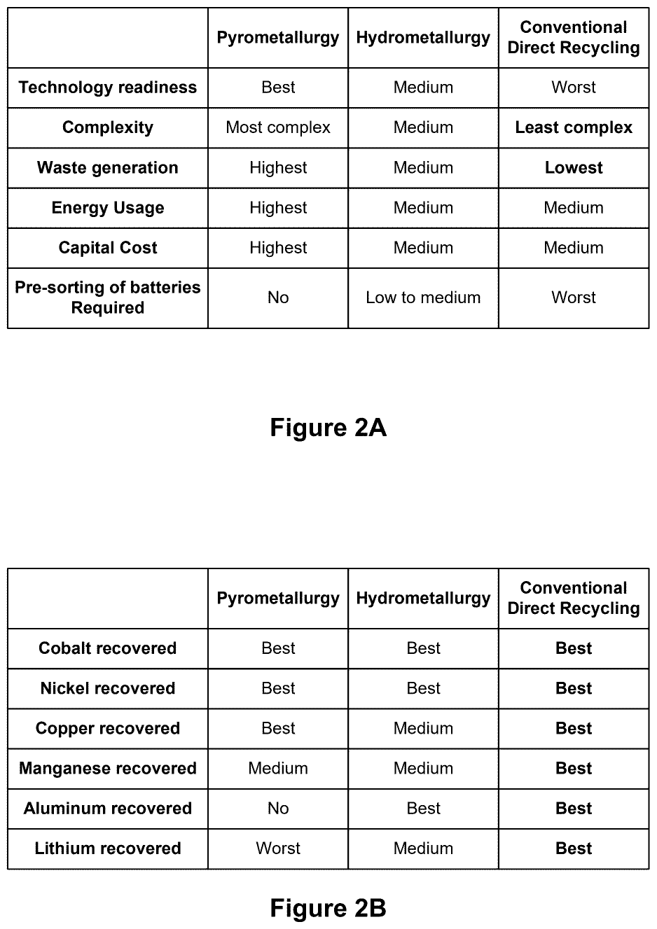

FIG. 1A illustrates current approaches 100 for recycling spent lithium ion batteries 102, in accordance with some embodiments. Pyrometallurgy 110, hydrometallurgy 140, and conventional direct recycling 170 are the three main pathways for recycling lithium ion batteries.

Pyrometallurgy 110 is a heat-based process that uses high heat to extract metals from spent batteries. Pyrometallurgy generally includes the step of disassembly 112, where the battery modules are deactivated, disassembled, and shredded to create a powder or granules 114. The powder or granules 114 are then subjected to a smelting process 116, where the powder or granules 114 are fed into a reactor that is heated to around 1500° C. The high heat melts the powder or granules 114 into slag 120 and a re-solidified a metal alloy 118. The metal alloy 118 is granulated and screened (122) to form black mass 124 (e.g., cathode active materials and graphite). The black mass 124 undergoes chemical separation processes 126, where it is chemically separated using acid treatment to dissolve the metal ions, followed by recovery processes 128, where the dissolved metal ions are recovered by precipitation or solvent extraction. FIG. 1B is a scanning electron microscope (SEM) image of an example particle (e.g., recovered metal materials 130) generated from the recovery processes 128. The diameter of the particle is about 12-15 μm. The recovered metal materials 130 are then reacted with other materials in the cathode synthesis step 132, to create new cathode materials (e.g., NMC particles 134) for batteries. FIG. 1C is a SEM image of an example NMC particle that is generated from the cathode synthesis step 132. The diameter of the particle is about 8-10 μm.

Hydrometallurgy 140 uses water-based solutions to dissolve and separate the metals from spent batteries. The spent batteries 102 first undergo a pretreatment process 142, which can include discharging and partly dismantling larger batteries, sorting the battery modules, physical separation, and mechanical treatment, including shredding, to produce a black mass 144. The black mass 144 is chemically separated (146) using techniques such as leaching, impurity removal, and purification. In the leaching step, the black mass 144 is leached with acids, bases, or reducing agents to dissolve the valuable metals. This is considered the most important step in recovering the metals. For impurity removal and purification, the metals are separated from impurities using chemical reactions. This can be done using hydrolytic precipitation, liquid-liquid reactions, or selective absorption. The metal ions are then recovered by precipitation 148. The SEM image in FIG. 1B shows an example particle (e.g., recovered metal materials 150) that is generated from the precipitation step 148. The recovered metal materials 150 are then reacted with other materials in the cathode synthesis step 152, to create new cathode materials (e.g., NMC particles 154) for batteries. The SEM image in FIG. 1C shows an example NMC particle 154 that is generated from the cathode synthesis 132.

In conventional direct recycling 170, the spent lithium ion batteries undergo one or more disassembly, selection and/or material separation processes 172, where the spent batteries are separated into battery components 174 (e.g., uncontaminated components) (e.g., anode, separator, and cathode). In some embodiments, the battery components 174 undergo shredding and size separation processes 176. After shredding, a feedstock of anode and cathode on their current collectors is generated. This feedstock contains the most valuable components in a lithium ion cell, including black mass 178 (e.g., active cathode materials and graphite), electrolyte, copper foils and aluminum foils. A particle screening and filtration step 180 is then performed, where cathode particles (e.g., polycrystalline particles) in the black mass 178 are screened to identify and select intact particles 182 whose physical structures are intact (i.e., not cracked) and/or have “better” states of health. The selected intact particles 182 then undergo a product rejuvenation process 184 in which their chemical compositions and lattice structures are restored by re-lithiation to generate NMC particles 186. In conventional direct recycling 170, particles whose physical structures are not intact (e.g., cracked particles) do not undergo the product rejuvenation step. Instead, they are re-routed for recycling using pyrometallurgy hydrometallurgy routes. The SEM image in FIG. 1C shows an example NMC particle that is generated from the product rejuvenation step 184.

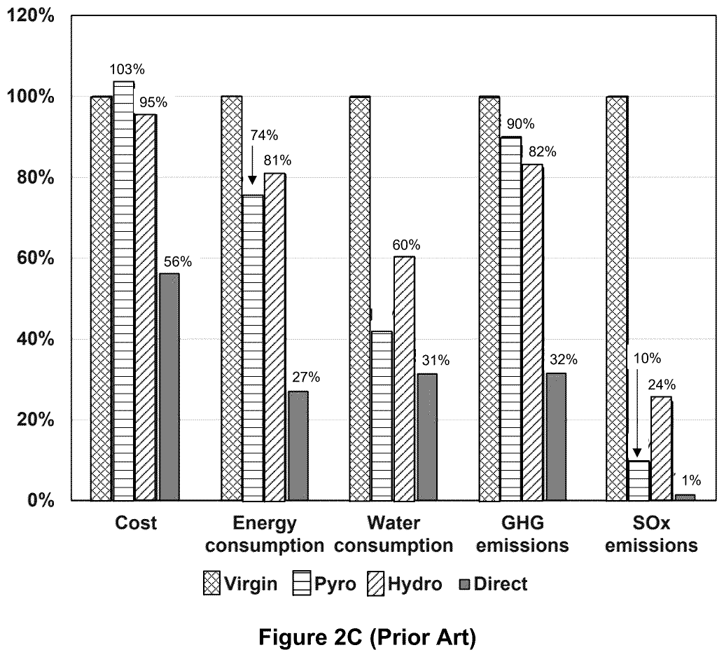

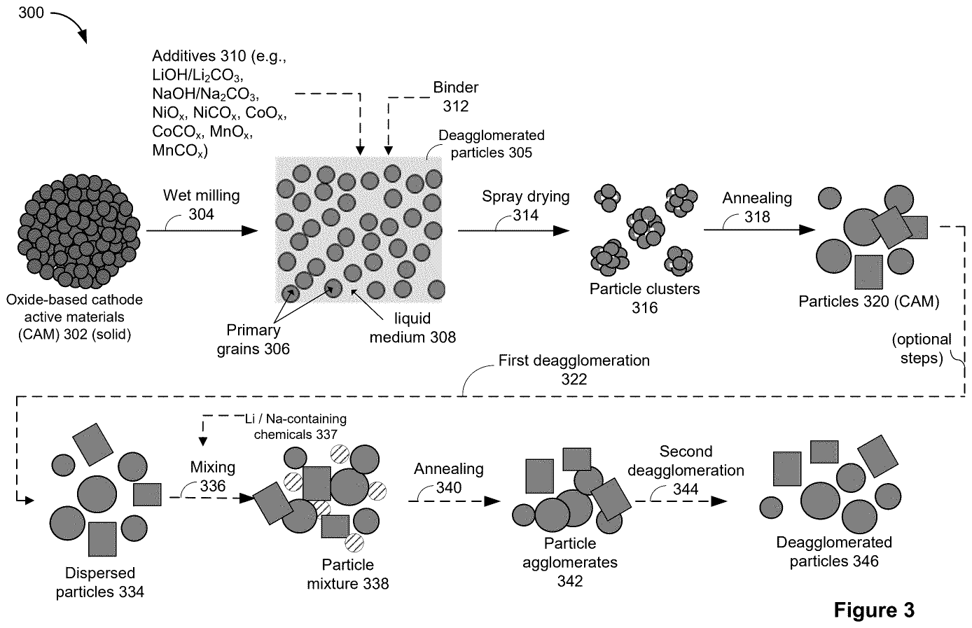

FIGS. 2A and 2B compares the current approaches for recycling lithium ion batteries, in accordance with some embodiments. These figures are adapted from Harper et al., “Recycling lithium-ion batteries from electric vehicles,” Nature 575, pp. 75-86 (2019), which is incorporated by reference herein in its entirety. FIG. 2A shows that of the three main pathways for recycling lithium ion batteries, conventional direct recycling is the least complex, has the lowest waste generation, and ranks best in terms of the quantity of recovered materials. However, it is also the least technology-ready and requires the most effort in terms of pre-sorting of batteries. Pyrometallurgy and hydrometallurgy produce the state-of-the-art recovered materials (e.g., 100% performance) but they are very costly. By comparison, conventional direct recycling may achieve ˜97% performance, but is cheaper and have easier processing steps compared to pyrometallurgy and hydrometallurgy.

FIG. 2B shows that of the three main pathways, conventional direct recycling ranks best in terms in recovering cobalt, nickel, copper, manganese, aluminum, and lithium.

FIG. 2C is a chart illustrating the cost and environmental impacts to produce 1 kg of NMC 111 from virgin raw materials and recycled pyrometallurgically, hydrometallurgically, and by conventional direct recycling, all alt large commercial scales (50,000 Tons/year). This figure is adapted from Gaines et al. “Direct Recycling R&D at the ReCEll Center,” Recycling 6, 31 (18 pp.) (2021), which is incorporated by reference herein in its entirety. FIG. 2C illustrates that direct recycling is shown to have the lowest impacts in all categories.

In view of the above, there is a need for improved systems and methods for direct recycling that would yield higher efficiency compared to conventional direct recycling approaches that exist today.

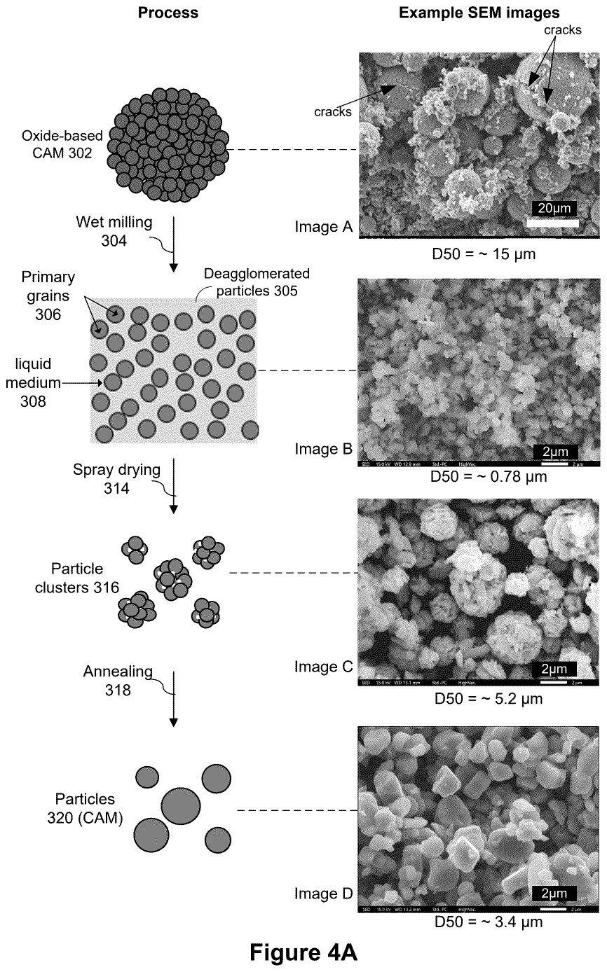

FIG. 3 illustrates an exemplary workflow 300 for direct recycling of batteries (e.g., cathode-to-cathode direct recycling), in accordance with some embodiments of the present disclosure. In accordance with some embodiments disclosed herein, the workflow 300 presents an improved method for cathode-to-cathode direct recycling and/or upcycling over existing direct recycling techniques that are available today because it incurs lower costs and produces zero waste.

In some embodiments, the workflow 300 is a workflow for cathode-to-cathode upcycling of oxide-based cathode active materials (CAM) 302, which are extracted from spent or used positive electrodes of lithium ion batteries (e.g., black mass) and/or sodium ion batteries, or from scrap batteries. In some embodiments, the oxide-based CAM 302 comprise polycrystalline particles. In some embodiments, the oxide-based CAM 302 include particles that are physically defective (e.g., not physically intact, contains cracks and/or fractures). In some embodiments, the oxide-based CAM 302 comprise a mixture of polycrystalline particles and single crystal particles. In some embodiments, the oxide-based CAM 302 includes one or more of the following chemical compositions: LiMn₂O₄, LiNiₓMn_{y}O₂ and NaNiₓMn_{y}O₂LiNiₐCo_{b}Mn_{c}O₂ (NCM) and LiNiₐCo_{b}Al_{c}O₂ (NCA), LiNi_{d}CoₑMn_{f}Al_{1-d-e-f}O₂ (NCMA), NaNCM, NaNCA, and NaNCMA, wherein x+y=1, 0≤x≤1, a+b+c=1, 0≤a≤1, 0≤b≤1, 0≤c≤1, 0≤d≤1, 0≤e≤1, and 0≤f≤1.

Referring to FIG. 3, in some embodiments, the oxide-based CAM 302 undergo a wet milling step 304, in which the oxide-based CAM 302 are wet milled using an aqueous medium. The wet milling step 304 causes the oxide-based CAM 302 to be deagglomerated into deagglomerated particles 305 comprising primary grains 306 suspended in a liquid medium 308. In some embodiments, the primary grains 306 have an average size (e.g., diameter) that is smaller than an average size of the oxide-based CAM 302.

In some embodiments, an upper limit of a median size (e.g., diameter) of a respective primary grain (e.g., a deagglomerated particle) may be around 4 microns (μm), 3 μm, 2 μm, 1 μm, 900 nanometers (nm), 800 nm, 700 nm, 600 nm, 500 nm, 400 nm, 300 nm, 200 nm or 100 nm. In some embodiments, a lower limit of a median size (e.g., diameter) of a respective primary grain (e.g., a deagglomerated particle) may be around 10 nm, 50 nm, 100 nm, 200 nm, 300 nm, 400 nm, 500 nm, 600 nm, or 700 nm. In some embodiments, a respective deagglomerated particle has a median size (e.g., diameter) ranging from about 400 nm to 4 μm, about 400 nm to 3 μm, about 400 nm to 2 μm, about 400 nm to 1 μm, about 500 nm to 4 μm, about 500 nm to 3 μm, about 500 nm to 2 μm, about 400 nm to 1 μm, about 600 nm to 4 μm, about 600 nm to 3 μm, about 600 nm to 2 μm, or about 600 nm to 1 μm.

In some embodiments, the aqueous medium is water (e.g., 100% water). In some embodiments, the aqueous medium comprises a mixture of water and one or more another liquid media. For example, in some embodiments, the other liquid medium can be ethanol or isopropanol (IPA), For example, in some embodiments, the aqueous medium comprises 95% water and 5% ethanol; or 90% water and 10% ethanol; or 85% water and 15% ethanol; or 95% water and 5% IPA, or 70% water and 30% IPA.

Water (100% water, or a medium that is predominantly water) is the preferred aqueous medium as it may significantly accelerate the deagglomeration of the oxide-based CAM 302. The mechanism is that the state-of-the-art polycrystalline CAM particles normally contain about 0.3 wt % to 1.0 wt % of residuals of lithium hydroxide (LiOH) and lithium carbonate (Li₂CO₃) or sodium hydroxide (NaOH) and sodium carbonate (Na₂CO₃), which exist between the boundaries of the primary grains and act as inorganic binders to uphold the integrity of the polycrystalline particles. These residuals may dissolve in water thus the deagglomeration of the polycrystalline particles may be significantly accelerated by wet milling in water.

In some embodiments, even if oxide-based CAM 302 are not upcycled (e.g., the chemistry or stoichiometry is not upgraded), it is necessary to compensate the lithium or sodium loss in the oxide-based CAM 302. This can be accomplished by adding chemicals such as LiOH/Li₂CO₃ (e.g., in the case of spent lithium ion batteries) or NaOH/Na₂CO₃ (e.g., in the case of spent sodium ion batteries). The additive content depends on the aging state of the used batteries and the prior processes to extract the polycrystalline materials.

In some embodiments, during the wet milling 304, one or more additives 310 such as LiOH, Li₂CO₃, NaOH, Na₂CO₃, nickel oxide, nickel carbonate, cobalt oxide, cobalt carbonate, manganese oxide, manganese carbonate, and/or aluminum oxide can be added to the deagglomerated particles 305 according to the chemistry upgrading strategies and/or to compensate the lithium or sodium loss in the cathode active materials.

In some embodiments, during the wet milling 304, a suitable amount of water-soluble polymer binder 312 (e.g., around 0.1 wt % to 0.5 wt %) is added into the suspension, which may help preserve the integrity of the particles during the subsequent annealing step(s) (e.g., annealing 318 or annealing 340). In some embodiments, the polymer binder 312 includes one or more of Methylcellulose (MC), Carboxymethyl Cellulose (CMC), Hydroxyethyl Cellulose (HEC), Hydroxypropyl Methylcellulose (HPMC), Carrageenan, polyvinyl alcohol (PVA), (polyethylene glycol) PEG, polyvinylpyrrolidone (PVP), Polypyrene (PPY), Polyacrylic Acid (PAA), Poly (methyl methacrylate) (PMMA).

Referring again to FIG. 3, in some embodiments, after the wet milling step 304, the deagglomerated particles 305 undergo a spray drying process 314, which reforms the smaller-sized (e.g., nanosized) primary grains into particle clusters 316 (e.g., secondary particles). In some embodiments, a respective particle cluster 316 is a micrometer-sized cluster. Compared with the original oxide-based CAM 302, which tend to be polycrystalline particles crystallized from the dense precursor polycrystalline particles, the particle clusters 316 have higher porosity because they are formed by low-density packing of randomly oriented primary grains. As a result, these secondary particles have poor mechanical strength and tend to collapse or sinter during annealing.

In some embodiments, an upper limit of a median size (e.g., diameter) of a respective particle cluster 316 may be around 1 μm, 2 μm, 3 μm, 4 μm, 5 μm, 6 μm, 7 μm, 8 μm, 9 μm, 10 μm, 11 μm, or 12 μm. In some embodiments, a lower limit of a median size (e.g., diameter) of a respective particle cluster 316 may be around 400 nm, 600 nm, 800 nm, 1 μm, 2 μm, 3 μm, 4 μm or 5 μm. In some embodiments, a respective particle cluster 316 has a median size (e.g., diameter) ranging from around 2 μm to 5 μm, 2 μm to 6 μm, 2 μm to 7 μm, 2 μm to 8 μm, 2 μm to 9 μm, 2 μm to 10 μm, 2 μm to 11 μm, 2 μm to 12 μm, 3 μm to 5 μm, 3 μm to 6 μm, 3 μm to 7 μm, 3 μm to 8 μm, 3 μm to 9 μm, 3 μm to 10 μm, 3 μm to 11 μm, 3 μm to 12 μm, 4 μm to 5 μm, 4 μm to 6 μm, 4 μm to 7 μm, 4 μm to 8 μm, 4 μm to 9 μm, 4 μm to 10 μm, 4 μm to 11 μm, or 4 μm to 12 μm.

With continued reference to FIG. 3, the particle clusters 316 are subjected to an annealing process 318 in which they are annealed (e.g., heated) at a first temperature (e.g., an elevated temperature) in a gaseous environment to form particles 320 (e.g., CAM particles). For example, in some embodiments, a lower limit of the first temperature is around 300° C., 400° C., 500° C., 550° C., 600° C., or 650° C. In some embodiments, an upper limit of the first temperature is around 550° C., 600° C., 650° C., 700° C., 750° C., 800° C., 850° C., 900° C., 950° C., 1000° C., or 1050° C. In some embodiments, the first temperature has a range around 400° C.-600° C., 400° C.-700° C., 400° C.-800° C., 400° C.-900° C., 400° C.-1000° C., 400° C.-1050° C., 500° C.-600° C., 500° C.-700° C., 500° C.-800° C., 500° C.-900° C., 500° C.-1000° C., or 500° C.-1050° C.

In some embodiments, the gaseous environment is air. In some embodiments, the gaseous environment is a predominantly oxygen environment (e.g., at least 51% oxygen by volume, at least 60% oxygen by volume, at least 70% oxygen by volume, at least 80% oxygen by volume, or at least 90% oxygen by volume).

In some embodiments, the particles 320 have a different morphology (e.g., shape and/or size) compared to the oxide-based CAM 302.

In some embodiments, the particles 320 have a different chemical composition (e.g., stoichiometry) compared to the oxide-based CAM 302. For example, in some embodiments, a respective particle of the particles 320 can have (i) a higher or lower lithium content (e.g., by % weight or % volume), or (ii) a higher or lower nickel content (e.g., by % weight or % volume), (iii) a higher or lower manganese content (e.g., by % weight or % volume), or (iv) a higher or lower cobalt content (e.g., by % weight or % volume) compared to a respective particle in the oxide-based CAM 302.

In some embodiments, the particles 320 have the same chemical composition as the oxide-based CAM 302.

In some embodiments, the particles 320 comprise individually-dispersed particles (e.g., particles that are not agglomerated, not clustered, or not aggregated, where adjacent particles are not joined together, etc.). For example, during the annealing process 318, particles within a cluster or different clusters of particles can coalesce or sinter together to form a respective particle of the particles 320.

In some embodiments, a lower limit of a median size (e.g., diameter) of a respective particle 320 may be around 300 nm, 400 nm, 500 nm, 600 nm, 700 nm, 800 nm, 900 nm, 1 μm, 2 μm, 3 μm, or 4 μm. In some embodiments, an upper limit of the median size (e.g., diameter) a respective particle 320 may be around 1 μm, 2 μm, 3 μm, 4 μm, 5 μm, 6 μm, 7 μm, or 8 μm. In some embodiments, a respective particle 320 has a median size (e.g., diameter) ranging from around 500 nm to 2 μm, 500 nm to 3 μm, 500 nm to 4 μm, 500 nm to 5 μm, 500 nm to 6 μm, 500 nm to 7 μm, 500 nm to 8 μm, 800 nm to 2 μm, 800 nm to 3 μm, 800 nm to 4 μm, 800 nm to 5 μm, 800 nm to 6 μm, 800 nm to 7 μm, 800 nm to 8 μm, 1 μm to 2 μm, 1 μm to 3 μm, 1 μm to 4 μm, 1 μm to 5 μm, 1 μm to 6 μm, 1 μm to 7 μm, 1 μm to 8 μm, 2 μm to 3 μm, 2 μm to 4 μm, 2 μm to 5 μm, 2 μm to 6 μm, 2 μm to 7 μm, or 2 μm to 8 μm.

In some embodiments, a respective particle in the particles 320 is a single crystal particle. In some embodiments, a respective particle in the particles 320 is a polycrystalline particle. In some embodiments, the particles 320 may include a mixture of single crystal particles and polycrystalline particles. For example, particles 320 having a smaller size (e.g., less than 1 μm, 2 μm, or 3 μm) may be single crystalline particles whereas particles 320 having a larger size (e.g., over 2 μm, 3 μm, 4 μm, or 5 μm) are polycrystalline particles.

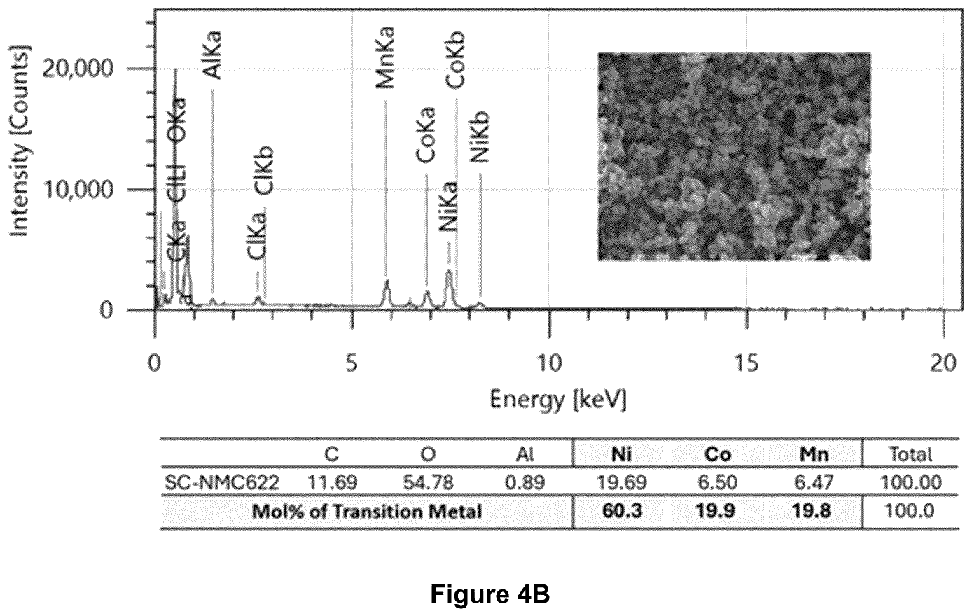

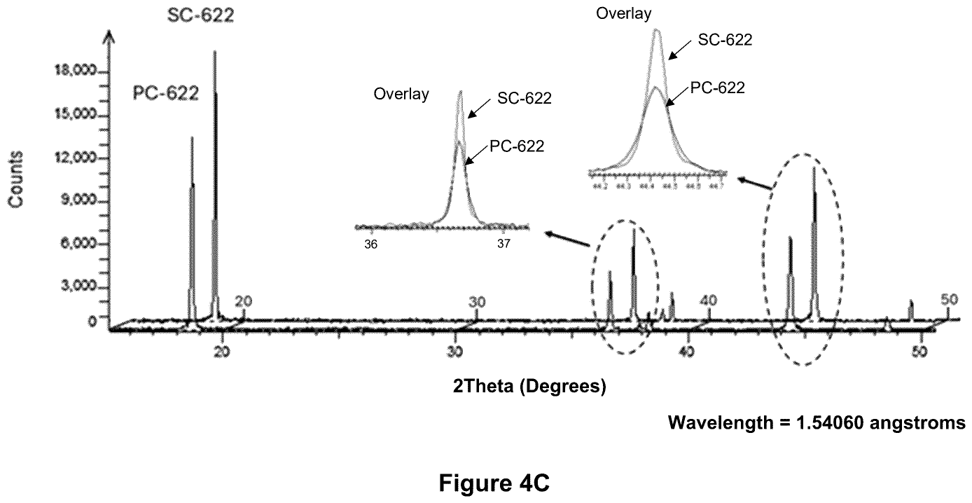

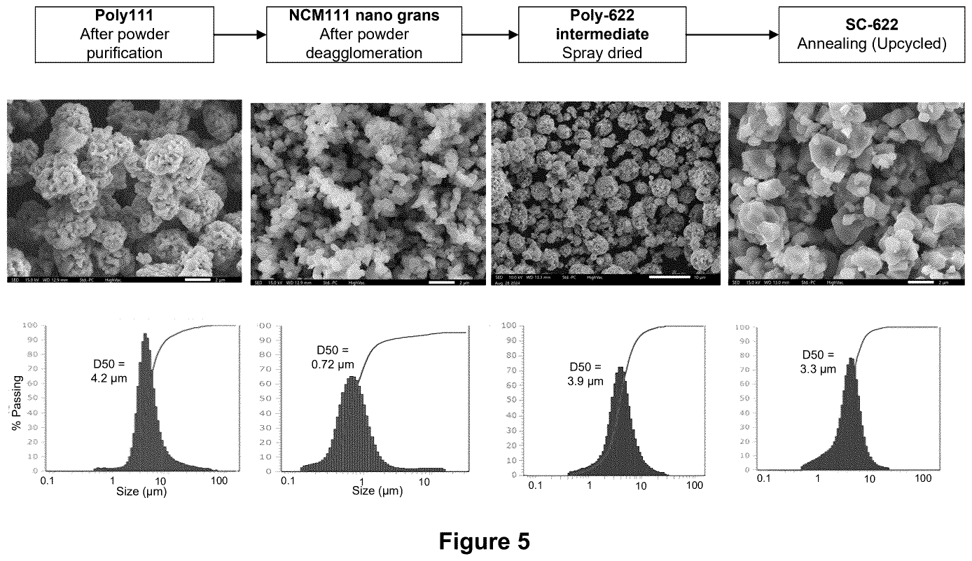

In some embodiments, the particles 320 have a different shape and/or size compared to CAM particles synthesized from pyrometallurgy or hydrometallurgy processes. For example, referring again to FIG. 1C, FIG. 1C shows an SEM image of an exemplary NMC particle that is generated from the cathode synthesis step in pyrometallurgy or hydrometallurgy. By contrast, image D in FIG. 4A shows an exemplary SEM image showing particles 320 that are synthesized using the wet milling, spray drying, and annealing processes disclosed herein. Compared to CAM particles that are synthesized from pyrometallurgy or hydrometallurgy processes, the particles 320 are more faceted and have a smaller median diameter.

In some embodiments, after the annealing process 318, the workflow 300 includes one or more additional steps such as a first deagglomeration process 322, a mixing step 336, a second annealing step 340, and a second deagglomeration process 344.

In some instances, the particles 320 that are obtained following the annealing step 318 may comprise aggregates (e.g., chains) of individual particles. In this scenario, the first deagglomeration process 322 is performed to break the particle aggregates to form dispersed particles 334. In some embodiments, the dispersed particles 334 have smaller average dimensions compared to the particles 320 (because the aggregates have been broken up) but retain the same chemical compositions as the particles 320. In some embodiments, the first deagglomeration process 322 comprises a jet milling process, a wet milling process, or a dry milling process, or a combination thereof.

In some embodiments, after the first deagglomeration process 322, the dispersed particles 334 are subjected to the mixing step 336, where they are mixed with LiOH, Li₂CO₃, NaOH, or Na₂CO₃ to obtain a particle mixture 338. In some embodiments, due to the high-temperature annealing process 318, the particles 320 may experience certain degrees of surface decomposition and lithium/sodium loss. To compensate for the lithium/sodium loss and recover the lattice order of the crystal surface, in some embodiments, lithium/sodium-containing chemicals 337 (e.g., compounds) may be added (e.g., as LiOH, Li₂CO₃, NaOH, or Na₂CO₃) to the particles after the first deagglomeration step 322. The rationale for performing the first deagglomeration step 322 before the mixing step 336 is because the first deagglomeration step 322 breaks up agglomerates that may be present in the particles 320 and increases the total surface areas of the particles, which in turn increases the likelihood that the particles 334 come into contact with (or mix with) the lithium/sodium-containing chemicals. After the mixing step 336, the particle mixture 338 is subjected to a second annealing step 340. The second annealing step 340 typically occurs at a lower temperature compared the first annealing step 318 and is applied for lattice order recovery and/or surface reconstruction of the particles.

For example, in some embodiments, a lower limit of the temperature of the second annealing step 340 is around 500° C., 520° C., 540° C., 550° C., 600° C., 650° C., 700° C., or 750° C. In some embodiments, an upper limit of the temperature of the second annealing step 340 is around 750° C., 800° C., or 850° C. In some embodiments, the temperature of the second annealing step 340 has a range of about 520° C.-770° C., 520° C.-800° C., 520° C.-850° C., 550° C.-770° C., 550° C.-800° C., or 550° C.-850° C. In one example, for NCM with at least 80% Ni (e.g., by weight percent, volume percent, or atomic percent), the second annealing step 340 is carried out at a temperature of around 500° C. to 560° C. (e.g., 550° C.) and may use LiOH which melts at 450° C. to ensure uniformity in the surface reconstruction. In one example, for NCM with Ni content that is 60% or under (e.g., by weight percent, volume percent, or atomic percent), the second annealing step 340 is carried out at a temperature of around 750° C. to 900° C. (e.g., 850° C.), and may use Li₂CO₃ which melts at 723° C. to ensure uniformity in the surface reconstruction.

In some embodiments, the second annealing step 340 occurs at a temperature that is about 550° C., 650° C., 750° C., or 850° C., which is lower than the temperature of the annealing process 318 (e.g., first annealing step for grain growth). In some embodiments, particle agglomerates 342 are formed after the second annealing step 340. In some embodiments, the particle agglomerates 342 are subjected to a second deagglomeration process 344 to produce deagglomerated particles 346.

In some embodiments, the size and/or shape of the particles 320 (e.g., primary grains) remain constant (e.g., do not change) once they have been formed in the first annealing step 318. In other words, in some embodiments, the optional processes of first deagglomeration 322, mixing 336, annealing 340, and/or second deagglomeration 344, when performed, not change the morphologies (e.g., shape and size) and/or crystallinity (e.g., polycrystalline or single crystalline) of the particles 320.

FIG. 4A are SEM images showing the morphology (e.g., shape and size) changes in the oxide based CAM 302 particles as they undergo the steps of wet milling 304, spray drying 314, and annealing 318 (e.g., first annealing), in accordance with some embodiments. In this example, the median particle size (D50) of the oxide-based CAM 302 is around 15 microns, the D50 of the particles after wet milling is around 0.78 microns, the D50 of the particles after spray drying is around 5.2 microns, and the D50 of the particles after the first annealing step is around 3.4 microns. Notably, SEM image A in FIG. 4A shows that the starting oxide-based CAM 302 can includes particles that are physically defective (e.g., contains cracks or fractures) and span over a large range of sizes. In some embodiments, the starting oxide-based CAM 302 are particles obtained from industrial manufacturing scrap of calendared electrode materials, where some particles are cracked or smashed into smaller grains when the electrode materials were subjected to the calendaring process.

FIG. 4B shows an energy dispersive X-ray (EDS) spectrum of a cluster of particles after the spray-drying process. The EDS data confirms the presence of Ni, Co, and Mn in these particles. Note that the lithium peaks are not present in the EDS spectrum because Li is a very light element (Z=3) and the Li K X-ray signals are of too low energy to be detected by EDS.

FIG. 4C shows X-ray diffraction (XRD) spectra of (i) the oxide-based CAM 302 particles (denoted as PC-622) before they undergo the steps of the workflow 300 and (ii) the particles after the first annealing step (denoted in SC-622). The SC-622 XRD spectrum is displaced both horizontally and vertically relative to the PC-622 XRD spectrum. Also shown are overlays of the peaks of the two spectra at around 2θ≈36.7° and 2θ≈44.5°. The SC-622 peaks are higher compared to the PC-622 peaks.

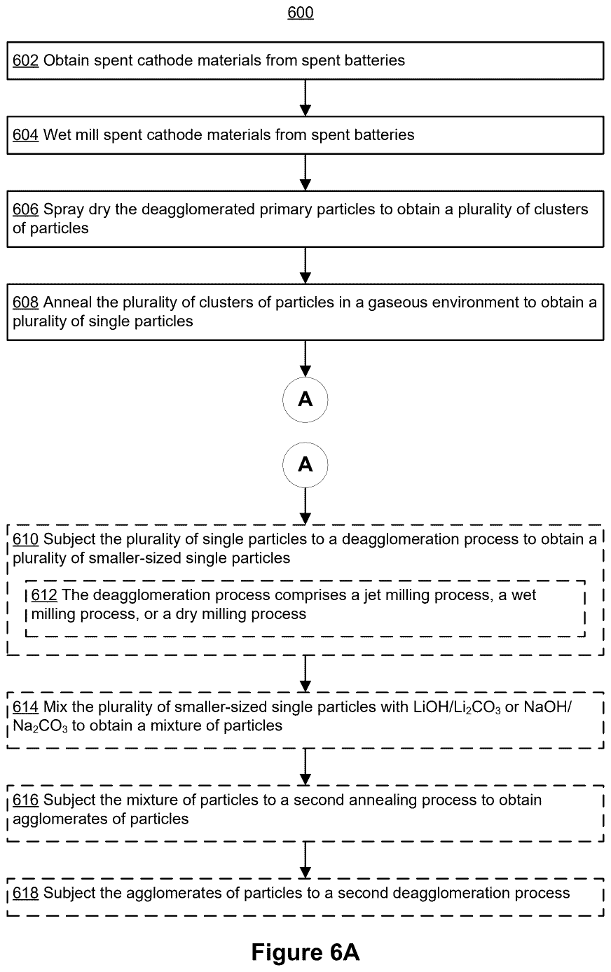

FIG. 5 illustrates morphological and size distribution changes of CAM particles during upcycling from NMC 111 (e.g., having a composition of Ni_{0.33}Mn_{0.33}Co_{0.33}) to NMC 622 (e.g., having a composition of Ni_{0.6}Mn_{0.6}Co_{0.6}), in accordance with some embodiments.

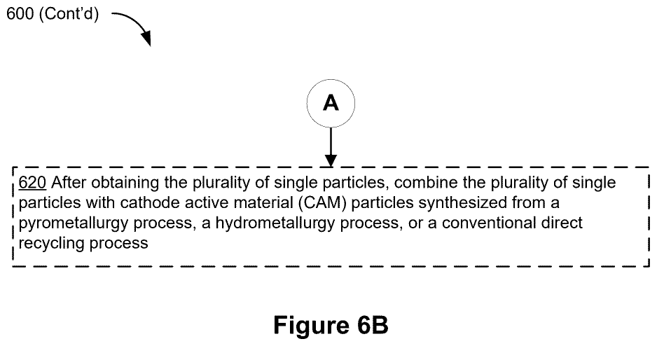

FIGS. 6A and 6B provide a flowchart of an example method 600 for direct recycling of batteries (e.g., cathode materials in spent batteries) or for direct cathode-to-cathode upcycling, in accordance with some embodiments. In some embodiments, upcycling refers to a change in particle morphology (e.g., shape and size). In some embodiments, upcycling refers to a change in chemical composition.

Referring to FIG. 6A, the method 600 includes obtaining (602) spent cathode materials from spent batteries. In some embodiments, the spent cathode materials are obtained from one or more of: unused cathode active materials (CAM), CAM extracted from cathode electrode scrapes, or CAM extracted from cathode electrodes of aged batteries. In some embodiments, the spent cathode materials include black mass (e.g., black mass 124, 144, or 178). In some embodiments, the spent cathode materials comprise polycrystalline particles (e.g., oxide-based CAM 302). The method includes wet milling (604) (e.g., via wet milling 304) the spent cathode materials in an aqueous medium to obtain deagglomerated particles (e.g., deagglomerated particles 305). The method includes spray drying (606) (e.g., via spray drying 314) the deagglomerated primary particles to obtain a plurality of clusters of particles (e.g., particle clusters 316). In some embodiments, a respective cluster of particles has a larger average or median size compared to a respective size of the deagglomerated primary particles). The method 600 includes annealing (608) the plurality of clusters of particles (e.g., via annealing 318) in a gaseous environment to obtain a plurality of single particles (e.g., individual particles, dispersed particles, non-agglomerated particles) (e.g., particles 320). In some embodiments, the plurality of single particles have the same chemical composition as the spent cathode materials. In some embodiments, the plurality of single particles have a different chemical composition from the spent cathode materials

In some embodiments, the method 600 includes, after annealing the plurality of clusters of particles to obtain the plurality of single particles, subjecting (610) the plurality of single particles to a deagglomeration process (e.g., first deagglomeration 322) to obtain a plurality of smaller-sized single particles (e.g., dispersed particles 334). In some embodiments, the annealing process 318 can cause multiple single particles to sinter and agglomerate. The deagglomeration process is applied to de-agglomerate the particles. In some embodiments, the deagglomeration process comprises (612) a jet milling process, or a wet milling process, or a dry milling process, or a combination thereof.

In some embodiments, the annealing 608 is a first annealing process and the deagglomeration process (in step 610) is a first deagglomeration process. In some embodiments, the method 600 includes after the first deagglomeration process, mixing (614) the plurality of smaller-sized single particles with LiOH/Li₂CO₃ or NaOH/Na₂CO₃ (e.g., via mixing step 336) to obtain a mixture of particles. In some embodiments, the method 600 includes, after the mixing, subjecting (616) the mixture of particles to a second annealing process (e.g., via annealing 340), to obtain agglomerates of particles (e.g., particle agglomerates 341). In some embodiments, the method 600 includes, after the second annealing process, subjecting (618) the agglomerates of particles to a second deagglomeration process (e.g., second deagglomeration 344) to obtain deagglomerated particles 346.

Referring to FIG. 6B, in some embodiments, the method 600 includes, after obtaining the plurality of single particles, combining (620) the plurality of single particles with cathode active material (CAM) particles synthesized from a pyrometallurgy process (e.g., pyrometallurgy 110), a hydrometallurgy process (e.g., hydrometallurgy 140), or a conventional direct recycling process (e.g., conventional direct recycling). In some embodiments, the plurality of single particles have a smaller size compared to the CAM particles synthesized from the pyrometallurgy process, the hydrometallurgy process, or the conventional direct recycling process. The smaller-sized particles can be dispersed between the larger-sized particles and occupy the voids or interstices between the larger-sized particles, thereby increasing an energy density of the final product.

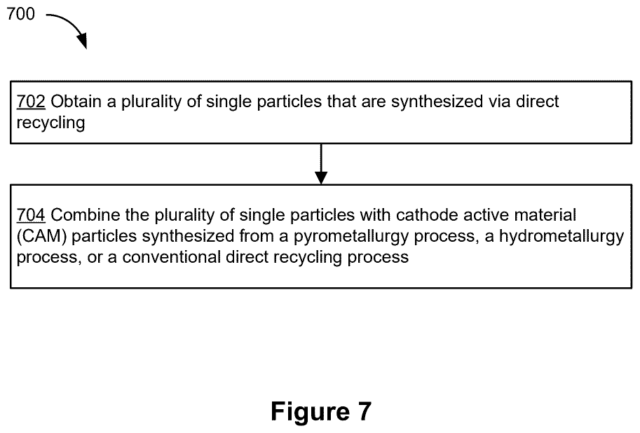

FIG. 7 provides a flowchart of an example method 700 for direct recycling of batteries (e.g., cathode materials in spent batteries) or for direct cathode-to-cathode upcycling, in accordance with some embodiments. In some embodiments, the steps in the method 700 can be combined with any of the steps in the method 600.

The method 700 includes obtaining (702) a plurality of single particles (e.g., particles 320) that are synthesized via direct recycling (e.g., via workflow 300). In some embodiments, the direct recycling includes a wet milling step, a spray drying step, and an annealing step as described with reference to FIGS. 3 and 6. The method 700 includes combining (704) the plurality of single particles with cathode active material (CAM) particles synthesized from a pyrometallurgy process (e.g., pyrometallurgy 110), a hydrometallurgy process (e.g., hydrometallurgy 140) or a conventional state-of-the-art CAM manufacturing process (e.g., conventional direct recycling 170). In some embodiments, CAM particles synthesized from pyrometallurgy, hydrometallurgy, or conventional direct recycling have a larger average/median diameter (e.g., around 10-15 μm) compared to the average/median diameter of the single particles (e.g., around 1-5 μm) synthesized using the improved direct recycling techniques disclosed herein. In some embodiments, the smaller-sized single particles occupy the spacings (e.g., voids or interstices) between the larger-sized CAM particles synthesized from pyrometallurgy, hydrometallurgy, or conventional direct recycling, thus creating a higher-density-packing product with increased energy density compared to a product that consists only of the larger-sized CAM particles.

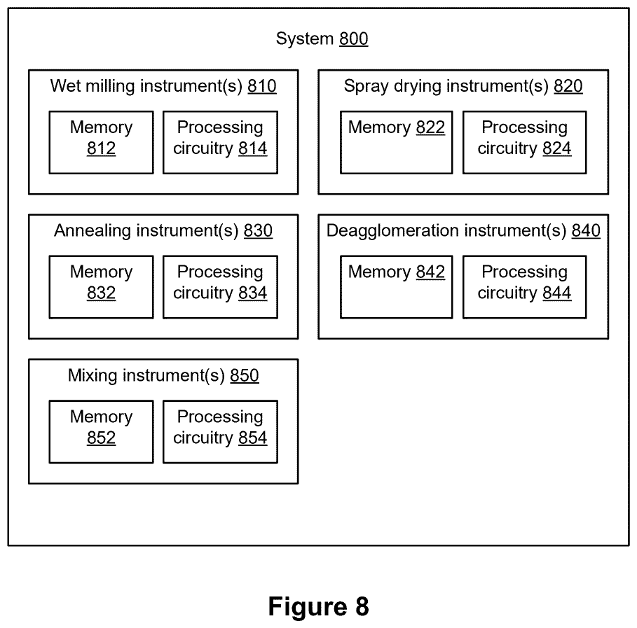

FIG. 8 illustrates an exemplary system 800 for performing the direct recycling and/or upcycling processes disclosed herein, in accordance with some embodiments.

In some embodiments, the system 800 includes one or more wet milling instruments 810 for performing the wet milling steps (e.g., wet milling 304). Examples of wet milling instruments include, and are not limited to, bead mills that use spherical balls or beads that tumble inside a rotating housing, colloid mills, wet ball mills that use a grinding medium and liquid for grinding materials, a multi-stage high shear dispersing machine for producing micro-emulsions, a cone mill for producing fine suspensions, a wet jet milling device that disperses, emulsifies, and pulverizes raw materials, and a high shear wet mill for submicron homogenizing and micronization. In some embodiments, the one or more wet milling instruments 810 include memory 812 and processing circuitry 814 (e.g., a central processing unit (CPU) or a processor). The memory 812 stores instructions that, when executed by the processing circuitry 814, cause the wet milling instruments 810 to perform any of the wet milling processes disclosed herein.

In some embodiments, the system 800 includes one or more spray drying instruments 820 for performing the spray drying step 314. In some embodiments, one or more spray drying instruments 820 are configured to produce dry granular powders from a slurry (e.g., a mixture of liquid solution and solid materials). In some embodiments, the spray drying instruments 820 include temperature controllers, rotating atomizer wheels or nozzles to produce dry powders by drying the slurry using a heated air stream. In some embodiments, the one or more spray drying instruments 820 include memory 822 and processing circuitry 824 (e.g., a central processing unit (CPU) or a processor). The memory 822 stores instructions that, when executed by the processing circuitry 824, cause the spray drying instruments 820 to perform any of the spray drying processes disclosed herein.

In some embodiments, the system 800 includes one or more annealing instruments 830 for performing one or more annealing steps (e.g., annealing 318 and/or annealing 340). The annealing instruments 830 can include one or more heating furnaces or ovens, one or more temperature controllers, and one or more gas sources and gas flow controllers. In some embodiments, the annealing instruments 830 include memory 832 and processing circuitry 834 (e.g., a central processing unit (CPU) or a processor). The memory 832 stores instructions that, when executed by the processing circuitry 834, cause the annealing instruments 830 to perform any of the annealing processes disclosed herein.

In some embodiments, the system 800 includes one or more deagglomeration instruments 840 for performing one or more deagglomeration steps (e.g., first deagglomeration 322 and second deagglomeration 344). The deagglomeration instruments 840 include memory 842 and processing circuitry 844 (e.g., a central processing unit (CPU) or a processor). The memory 842 stores instructions that, when executed by the processing circuitry 844, cause the annealing instruments 830 to perform any of the deagglomeration processes disclosed herein.

In some embodiments, the system 800 includes one or more mixing instruments 850 for performing one or more mixing steps (e.g., mixing step 336). The mixing instruments 850 include memory 852 and processing circuitry 854 (e.g., a central processing unit (CPU) or a processor). The memory 852 stores instructions that, when executed by the processing circuitry 854, cause the mixing instruments 850 to perform any of the mixing processes disclosed herein.

### EXAMPLES

This section describes four working examples. In Example 1, aged oxide-based CAM particles are processed using the workflow 300 where the polycrystalline particles are subjected to one annealing step and one deagglomeration step. The process transforms a respective particle from a polycrystalline particle to a single crystal particle. Examples 2 to 4 describe three upgrading processes corresponding to (i) changes in crystallinity (e.g., polycrystalline to single crystallinity) and morphology without chemical composition changes (NMC 622 to NMC 622) in Example 2, (ii) crystallinity changes (E.g., from polycrystallinity to single crystallinity) without chemical composition changes in Example 3, and (iii) morphological, crystallinity and chemical composition changes in Example 4.

### Example 1. Morphology Upgrading of Fresh Unused NMC 622 from Polycrystal to Single Crystal NMC 622 (One Annealing Step and One Deagglomeration Step)

5.0 kg aged NMC 622 polycrystalline particles extracted from used battery cells were milled together with 285 grams of Li₂CO₃ (Li₂CO₃ is added here in advance to compensate the lithium loss during annealing, also may act as a liquid flux melting at 723° C. to accelerate the grain growth at 900° C. in this example), 10 g CMC and 5.0 kg deionized (DI) water in a pin-type grinder for 3 hours at 1000 rpm. The grinding ended when the D50 stabilized at 0.7 μm±0.05 μm.

After wet milling, the aqueous suspension was then spray dried into secondary microparticles with D50 of 4.8 μm. The solid concentration in the slurry was 50%, the air pressure was set at 0.4 mPa, the flow rate was 100 mL/min, and drying temperature was 220° C.

The spray dried sample was loaded in a saggar and annealed at 900° C. for 6 hours (lower temperature forms smaller SC-NMC 622 of D50=2.5 μm, experience certain surface decomposition but basically no lithium loss) in a box furnace with an O₂ flow rate of 12 liters per minute, then cooled down to 750° C. and held at that temperature for 6 hours (for surface lattice order recovery), and then cooled down to room temperature.

### Example 2. Morphology Upgrading of Fresh Unused NMC 622 from Polycrystal to Single Crystal NMC 622 (Two Annealing Steps and One Deagglomeration Step)

5.0 kg fresh unused NMC 622 polycrystalline particles were milled together with 10 g CMC and 5.0 kg deionized (DI) water in a pin-type grinder for 3 hours at 1000 rpm. The grinding ended when the D50 stabilized at 0.7 μm±0.05 μm.

After wet milling, the aqueous suspension was then spray dried into secondary microparticles with D50 of 4.8 μm. The solid concentration in the slurry was 50%, the air pressure was set at 0.4 mPa, the flow rate was 100 mL/min, and drying temperature was 220° C.

The spray dried sample was loaded in a saggar and annealed at 970° C. for 3 hours in a box furnace with an O₂ flow rate of 12 liters per minute and then cooled down to room temperature.

The annealed sample was jet milled and mixed with 108 g LiOH·H₂O power, then annealed at 600° C. for 6 hours.

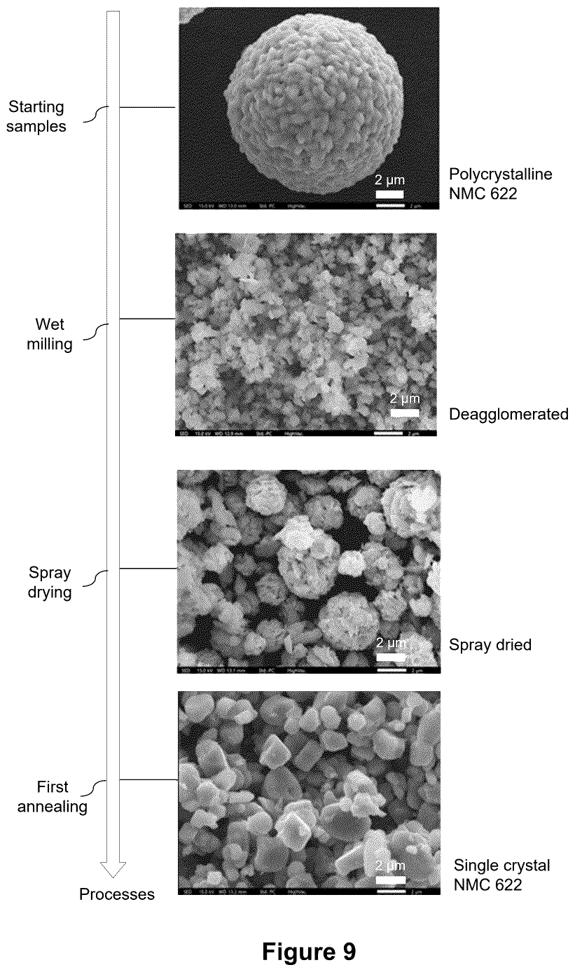

FIG. 9 are SEM images showing the morphological changes in the sample during the whole process.

### Example 3. Morphology Upgrading of Aged NMC 622 from Polycrystal to Single Crystal NMC 622 (Two Annealing Steps and One Deagglomeration Step)

5.0 kg aged NMC 622 polycrystalline particles extracted from used battery cells were milled together with 285 grams of Li₂CO₃, 20 g of PVA and 5.0 kg of DI water in a pin-type grinder for 2 hours at 1500 rpm. The grinding ended when the D50 stabilized at 0.8 μm±0.05 μm.

After wet milling, the aqueous suspension was then spray dried into secondary microparticles with D50 of 5.0 μm. The solid concentration in the slurry was 30%, the air pressure was set at 0.3 mPa, the flow rate was 100 mL/min, and the drying temperature was 210° C.

The spray dried sample was loaded in a saggar and annealed at 940° C. for 6 hours in a box furnace with an O₂ flow rate of 12 liter per minute and then cooled down to room temperature.

The annealed sample was jet milled and mixed with 43 g LiOH·H2O powder, then annealed at 750° C. for 4 hours.

### Example 4. Upgrading of Aged Polycrystal NMC 622 to Single Crystal NCM811

3.0 kg aged NCM622 polycrystalline particles extracted from used battery cells were milled together with 2310 g nano-powder of NiO, 628 g Li₂CO3, 5 g HPMC, and 5.0 kg DI water in a pin-type grinder for 2 hours at 1200 rpm.

After wet milling, the aqueous suspension was then spray dried into secondary microparticles with D50 of 4.5 μm. The solid concentration in the slurry was 40%, the air pressure was set at 0.4 mPa, the flow rate was 100 mL/min, and the drying temperature was 230° C.

The spray dried sample was loaded in a saggar and annealed at 920° C. in a box furnace with an O₂ flow rate of 12 liter per minute and then cooled down to room temperature.

The annealed particles were then jet milled and mixed with 90 g LiOH·H₂O power, where the molar ratio of lithium to the total transition metals Li/TM=2%.

The mixed sample was then annealed at 650° C. for 6 hours.

Table 1 below shows the characterization results of all the examples. In these examples, polycrystalline NMC 622 (PC-622) are individual particles (e.g., dispersed, not agglomerated).

TABLE 1
Characterization results of Examples 1, 2, 3, and 4

| | | Initial | Initial | 1^{st} |
|---|---|---|---|---|
| | | Charging | Discharging | Cycle |
| | D50 | Capacity @1/20 | Capacity @1/20 | Columbic |
| | (μm) | C (mAh/g) | C (mAh/g) | Efficiency |
| SC-622 | 2.65 | 189.3 | 177.5 | 93.7% |
| (Example 1) | | | | |
| SC-622 | 3.13 | 192.4 | 181.2 | 94.2% |
| (Example 2) | | | | |
| SC-622 | 3.28 | 191.8 | 180.7 | 94.3% |
| (Example 3) | | | | |
| SC-811 | 3.05 | 207.2 | 197.1 | 95.1% |
| (Example 4) | | | | |

### Example Embodiments

Turning on to some example embodiments:

(A1) In accordance with some embodiments, a method for direct recycling of batteries comprises (i) obtaining spent cathode materials from spent batteries; (ii) wet milling the spent cathode materials in an aqueous medium to obtain deagglomerated particles; (iii) spray drying the deagglomerated particles to obtain a plurality of clusters of particles; and (iv) annealing the plurality of clusters of particles in a gaseous environment to obtain a plurality of single particles.

(A2) In some embodiments of A1, the method includes, after annealing the plurality of clusters of particles to obtain the plurality of single particles: subjecting the plurality of single particles to a deagglomeration process to obtain a plurality of smaller-sized single particles.

(A3) In some embodiments of A2, the deagglomeration process is a jet milling process.

(A4) In some embodiments of A2 or A3, the annealing is a first annealing process and the deagglomeration process is a first deagglomeration process. The method further includes, after the first deagglomeration process: (i) mixing the plurality of smaller-sized single particles with LiOH/Li₂CO₃ or NaOH/Na₂CO₃ to obtain a mixture of particles; and (ii) subjecting the mixture of particles to a second annealing process, to obtain agglomerates of particles.

(A5) In some embodiments of A4, a temperature of the first annealing process is higher than a temperature of the second annealing process.

(A6) In some embodiments of A4 or A5, the method further includes: after the second annealing process, subjecting the agglomerates of particles to a second deagglomeration process.

(A7) In some embodiments of any of A1-A6, the aqueous medium includes water.

(A8) In some embodiments of any of A1-A7, the method further includes: while wet milling the spent cathode materials, adding a water-soluble polymer binder to an aqueous suspension of the spent cathode materials.

(A9) In some embodiments of A8, the polymer binder includes one or more of: Methylcellulose (MC), Carboxymethyl Cellulose (CMC), Hydroxyethyl Cellulose (HEC), Hydroxypropyl Methylcellulose (HPMC), Carrageenan, polyvinyl alcohol (PVA), (polyethylene glycol) PEG, polyvinylpyrrolidone (PVP), Polypyrene (PPY), Polyacrylic Acid (PAA), and Poly (methyl methacrylate) (PMMA).

(A10) In some embodiments of A8 or A9, a weight content of the polymer binder ranges from 0.05 wt % to 2.0 wt %.

(A11) In some embodiments of any of A1-A10, the method further includes: while wet milling the spent cathode materials, adding LiOH/Li₂CO₃ or NaOH/Na₂CO₃ to an aqueous suspension of the spent cathode materials.

(A12) In some embodiments of any of A1-A11, the method further includes: while wet milling the spent cathode materials, adding one or more additives to an aqueous suspension of the spent cathode materials.

(A13) In some embodiments of A12, the one or more additives include one or more of: LiOH, Li₂CO₃, NaOH, Na₂CO₃, nickel oxide/carbonate, cobalt oxide, cobalt carbonate, manganese oxide, manganese carbonate, or aluminum oxide.

(A14) In some embodiments of any of A1-A13, a respective deagglomerated particle has a median diameter ranging from about 500 nanometers (nm) to 3 micrometers (μm).

(A15) In some embodiments of any of A1-A14, a respective cluster of particles has a median diameter ranging from about 3 micrometers to 8 micrometers.

(A16) In some embodiments of any of A1-A15, the gaseous environment comprises an oxygen environment.

(A17) In some embodiments of any of A1-A16, the gaseous environment comprises air.

(A18) In some embodiments of any of A1-A17, the annealing occurs at a temperature between 500° C. and 1000° C. inclusive.

(A19) In some embodiments of any of A1-A18, a respective single particle is a single crystalline particle.

(A20) In some embodiments of any of A1-A19, each single particle of the plurality of single particles is a single crystalline particle.

(A21) In some embodiments of any of A1-A19, a respective single particle is a polycrystalline particle.

(A22) In some embodiments of any of A1-A18 or A21, each single particle of the plurality of single particles is a polycrystalline particle.

(A23) In some embodiments of any of A1-A22, a respective single particle has a median diameter ranging from about 1.0 micrometers to 6.0 micrometers.

(A24) In some embodiments of any of A1-A23, the plurality of single particles have a different shape from cathode active material (CAM) particles synthesized from pyrometallurgy or hydrometallurgy processes.

(A25) In some embodiments of any of A1-A24, the spent cathode materials include a material selected from the group consisting of LiMn₂O₄, LiNiₓMn_{y}O₂ and NaNiₓMn_{y}O₂LiNiₐCo_{b}Mn_{c}O₂ (NCM) and LiNiₐCo_{b}Al_{c}O₂ (NCA), LiNi_{d}CoₑMn_{f}Al_{1-d-e-f}O₂ (NCMA), NaNCM, NaNCA, and NaNCMA, wherein x, y, z, a b, c, d, e, and f satisfy the conditions: x+y=1, 0≤x≤1, a+b+c=1, 0≤a≤1, 0≤b≤1, 0≤c≤1, 0≤d≤1, 0≤e≤1, and 0≤f≤1.

(A26) In some embodiments of any of A1-A25, the spent cathode materials are obtained from one or more of: unused cathode active materials (CAM), CAM extracted from cathode electrode scrapes, or CAM extracted from cathode electrodes of aged batteries.

(A27) In some embodiments of any of A1-A26, the plurality of single particles have the same chemical composition as the spent cathode materials.

(A28) In some embodiments of any of A1-A26, the plurality of single particles have a different chemical composition from the spent cathode materials.

(A29) In some embodiments of any of A1-A28, the method further includes: after obtaining the plurality of single particles, mixing the plurality of single particles with cathode active material (CAM) particles synthesized from pyrometallurgy or hydrometallurgy processes or the conventional state-of-the-art CAM manufacturing process.

(A30) In some embodiments of any of A1-A29, the spent batteries are lithium-ion batteries.

(A31) In some embodiments of any of A1-A29, the spent batteries are sodium-ion batteries.

(B1) In accordance with some embodiments, a method of using particles of cathode active materials obtained via direct recycling includes (i) obtaining a plurality of single particles comprising CAM materials, wherein the single particles processed via a direct recycling process; and (ii) combining the plurality of single particles with cathode active material (CAM) particles synthesized from pyrometallurgy or hydrometallurgy processes or from a conventional direct recycling process.

(B2) In some embodiments of B1, the direct recycling process includes a wet milling process, a spray drying process, and an annealing process.

(C1) In some embodiments, a system for direct recycling of batteries includes processing circuitry and memory, The memory stores instructions that are configured to be executed by the processing circuitry. The instructions, when executed by the processing circuitry, cause the system to perform the method of any of A1-A31 or B1-B2.

(D1) Cathode active material (CAM) particles, comprising: a nickel-based sodium transition metal oxide, including sodium (Na), nickel (Ni), cobalt (Co), and manganese (Mn).

(D2) The CAM particles of D1, wherein the Ni, the Co, and the Mn are of about equi-atomic proportions.

(D3) The CAM particles of D1, wherein the Co and the Mn have about equal atomic proportions and the Ni has an atomic proportion that exceeds the sum of the atomic proportions of the Co and Mn.

(D4) The CAM particles of any of D1-D3, wherein a respective CAM particle is a single crystal particle.

(D5) The CAM particles of any of D1-D4, wherein a respective CAM particle has a dimension ranging from about 1.0 micrometers to 6.0 micrometers.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

As used herein, the phrase “based on” does not mean “based only on,” unless expressly specified otherwise. In other words, the phrase “based on” describes both “based only on” and “based at least on.”

As used herein, the term “exemplary” means “serving as an example, instance, or illustration,” and does not necessarily indicate any preference or superiority of the example over any other configurations or implementations.

As used herein, the term “and/or” encompasses any combination of listed elements. For example, “A, B, and/or C” includes the following sets of elements: A only, B only, C only, A and B without C, A and C without B, B and C without A, and a combination of all three elements, A, B, and C.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

What is claimed is:

1. A method for direct recycling of batteries, comprising:
obtaining spent cathode materials from spent batteries
wet milling the spent cathode materials in an aqueous medium to obtain deagglomerated particles;
spray drying the deagglomerated particles to obtain a plurality of clusters of particles; and
annealing the plurality of clusters of particles in a gaseous environment to obtain a plurality of single particles.

2. The method of claim 1, further comprising:
after annealing the plurality of clusters of particles to obtain the plurality of single particles:
subjecting the plurality of single particles to a deagglomeration process to obtain a plurality of smaller-sized single particles.

3. The method of claim 2, wherein the deagglomeration process is a jet milling process.

4. The method of claim 2, wherein the annealing is a first annealing process and the deagglomeration process is a first deagglomeration process, the method further comprising:
after the first deagglomeration process:
mixing the plurality of smaller-sized single particles with LiOH/Li₂CO₃ or NaOH/Na₂CO₃ to obtain a mixture of particles; and
subjecting the mixture of particles to a second annealing process, to obtain agglomerates of particles.

5. The method of claim 4, wherein a temperature of the first annealing process is higher than a temperature of the second annealing process.

6. The method of claim 4, further comprising:
after the second annealing process, subjecting the agglomerates of particles to a second deagglomeration process.

7. The method of claim 1, further comprising:
while wet milling the spent cathode materials, adding a water-soluble polymer binder to an aqueous suspension of the spent cathode materials,
wherein the water-soluble polymer binder includes one or more of: Methylcellulose (MC), Carboxymethyl Cellulose (CMC), Hydroxyethyl Cellulose (HEC), Hydroxypropyl Methylcellulose (HPMC), Carrageenan, polyvinyl alcohol (PVA), (polyethylene glycol) PEG, polyvinylpyrrolidone (PVP), Polypyrene (PPY), Polyacrylic Acid (PAA), and Poly (methyl methacrylate) (PMMA).

8. The method of claim 7, wherein a weight content of the water-soluble polymer binder ranges from 0.05 wt % to 2.0 wt %.

9. The method of claim 1, further comprising:
while wet milling the spent cathode materials:
adding LiOH/Li₂CO₃ or NaOH/Na₂CO₃ to an aqueous suspension of the spent cathode materials; and
adding one or more additives to an aqueous suspension of the spent cathode materials, the one or more additives including one or more of: LiOH, Li₂CO₃, NaOH, Na₂CO₃, nickel oxide/carbonate, cobalt oxide, cobalt carbonate, manganese oxide, manganese carbonate, or aluminum oxide.

10. The method of claim 1, wherein the gaseous environment comprises an oxygen environment or air.

11. The method of claim 1, wherein the annealing occurs at a temperature between 500° C. and 1000° C. inclusive.

12. The method of claim 1, wherein a respective single particle is a single crystalline particle.

13. The method of claim 1, wherein a respective single particle is a polycrystalline particle.

14. The method of claim 1, wherein a respective single particle has a median diameter ranging from about 1.0 micrometers to 6.0 micrometers.

15. The method of claim 1, wherein the spent cathode materials are selected from the group consisting of LiMn₂O₄, LiNiₓMn_{y}O₂ and NaNiₐMn_{b}O₂LiNiₐCo_{b}Mn_{c}O₂ (NCM) and LiNiₐCo_{b}Al_{c}O₂ (NCA), LiNi_{d}CoₑMn_{f}Al_{1-d-e-f}O₂ (NCMA), NaNCM, NaNCA, and NaNCMA;
wherein x+y=1, 0<x≤1, a+b+c=1, 0≤a≤1, 0≤b≤1, 0≤c≤1, 0≤d≤1, 0≤e ≤1, and 0≤f≤1.

16. The method of claim 1, wherein the spent cathode materials are obtained from one or more of: unused cathode active materials (CAM), CAM extracted from cathode electrode scrapes, or CAM extracted from cathode electrodes of aged batteries.

17. The method of claim 1, further comprising:
after obtaining the plurality of single particles, mixing the plurality of single particles with cathode active material (CAM) particles synthesized using a pyrometallurgy process, a hydrometallurgy process, or a conventional state-of-the-art CAM manufacturing process.

18. The method of claim 1, wherein the spent batteries are lithium-ion batteries or sodium-ion batteries.

19. A method of using particles of cathode active materials obtained via direct recycling, comprising:
obtaining a plurality of single particles comprising CAM materials, wherein the single particles processed via a direct recycling process; and
combining the plurality of single particles with cathode active material (CAM) particles synthesized from pyrometallurgy or hydrometallurgy processes or from a conventional direct recycling process different from the direct recycling process.

20. The method of claim 19, wherein the direct recycling process includes a wet milling process, a spray drying process, and an annealing process.
